(19) United States
(12) Patent Application Publication
(10) Pub. No.: US 2017/0081937 A1
(43) Pub. Date: Mar. 23, 2017

(54) DOWNHOLE SEAL

(71) Applicant: Weatherford Technology Holdings, LLC, Houston, TX (US)

(72) Inventor: Rocky A. TURLEY, Houston, TX (US)

(21) Appl. No.: 15/273,048

(22) Filed: Sep. 22, 2016

Related U.S. Application Data
(60) Provisional application No. 62/222,620, filed on Sep. 23, 2015.

(51) Int. Cl. E21B 33/12; F16J 15/02

(52) U.S. Cl. CPC E21B 33/1208; F16J 15/022

(57) ABSTRACT

A seal having a cylindrical body; a plurality of exterior sealing elements disposed on an exterior surface of the body; and a plurality of interior sealing elements disposed on an interior surface of the body, wherein the exterior sealing elements are offset from the interior sealing elements along the body.

### BACKGROUND OF THE DISCLOSURE

Field of the Disclosure

The present disclosure generally relates to apparatus and methods for sealing between two tubulars. In particular, embodiments of the present disclosure relate to a seal between a polished bore receptacle and a tubular mandrel.

Description of the Related Art

Many different types of seals have been used to handle high temperature and pressure downhole applications. Some applications involve seals on tools that have to engage a seal bore receptacle downhole in an extreme temperature and pressure environment. For example, a tubular such as a production tubing may be “stabbed” into a liner downhole.

Chevron shaped sealing members have typically been used to seal between the tubular and the liner. Because chevron shaped sealing members provide only unidirectional sealing, one or more pairs of these sealing members are arranged 180 degrees apart on the tubular.

However, Chevron seals are problematic because they have pressure limitations and can trap pressure between the seals, thereby damaging the seals after they are pulled out of the PBR. The Chevron seals may also be damaged or washed off if the tripped in speed is too fast, thereby limiting the trip in speed.

There is, therefore, a need for an improved seal for use with a mandrel that can be stabbed into another tubular.

### SUMMARY OF THE DISCLOSURE

In one embodiment, a downhole seal includes cylindrical body; a plurality of exterior sealing elements disposed on an exterior surface of the body; and a plurality of interior sealing elements disposed on an interior surface of the body, wherein the exterior sealing elements are offset from the interior sealing elements along the body.

In another embodiment, a downhole seal includes a first sealing member and a second sealing member, wherein each of the first and second sealing members includes a cylindrical body; a plurality of exterior sealing elements disposed on an exterior surface of the body; and a plurality of interior sealing elements disposed on an interior surface of the body, wherein the exterior sealing elements are offset from the interior sealing elements along the body. The seal also includes a third sealing member disposed between the first sealing member and the second sealing member.

In another embodiment, a downhole seal includes a cylindrical body; a plurality of exterior sealing elements disposed at an angle on an exterior surface of the body; and a plurality of interior sealing elements disposed at an angle on an interior surface of the body, wherein the exterior sealing elements are aligned with the interior sealing elements and angled in the same direction.

In another embodiment, a downhole seal includes a first sealing member; a second sealing member, wherein each of the first and second sealing members includes a cylindrical body; a plurality of exterior sealing elements disposed at an angle on an exterior surface of the body; and a plurality of interior sealing elements disposed at an angle on an interior surface of the body, wherein the exterior sealing elements are aligned with the interior sealing elements and angled in the same direction; and a third sealing member disposed between the first sealing member and the second sealing member, wherein the respective sealing elements of the first sealing member and the second sealing member are angled in opposite directions.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 shows a cross-sectional view of an embodiment of a downhole seal disposed around a mandrel.

FIG. 2 is a cross-sectional view of an embodiment of a sealing member.

FIG. 3 is an enlarged, partial view of the sealing member of FIG. 2.

FIG. 3A is an enlarged, partial view of the sealing member of FIG. 3 in operation.

FIG. 4 illustrates another embodiment of a seal.

FIG. 5 is an enlarged partial view of the seal of FIG. 4.

FIG. 6 is an enlarged partial view of the seal of FIG. 4.

FIG. 7 shows a cross-sectional view of another embodiment of a downhole sealing member.

FIG. 8 is an enlarged, partial view of the sealing member of FIG. 7.

FIG. 9 is an enlarged partial view of the sealing member of FIG. 8.

FIG. 10 is an enlarged partial view of the sealing member of FIG. 8.

FIG. 11 shows a cross-sectional view of another embodiment of a downhole seal.

FIG. 12 is an enlarged, partial view of the sealing member of FIG. 11.

FIG. 13 is an enlarged partial view of the sealing member of FIG. 12.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

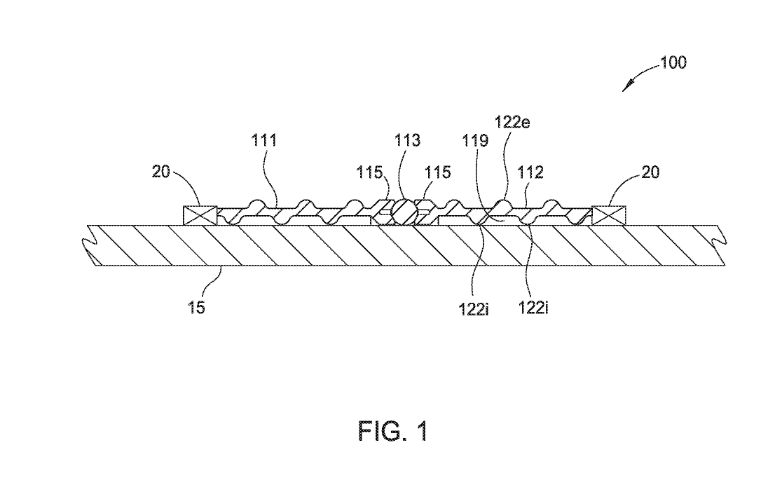

FIG. 1 shows a cross-sectional view of an embodiment of a downhole seal 100 disposed around a mandrel 15 that is configured to be stabbed into a tubular such as a polished bore receptacle (“PBR”) or a liner. The seal 100 is disposed between two protrusions 20 for axially retaining the seal 100 on the mandrel 15. The protrusions 20 may be attached to the mandrel 15 or formed integrally with the mandrel 15. In one embodiment, the seal 100 may be disposed on a recess in the mandrel.

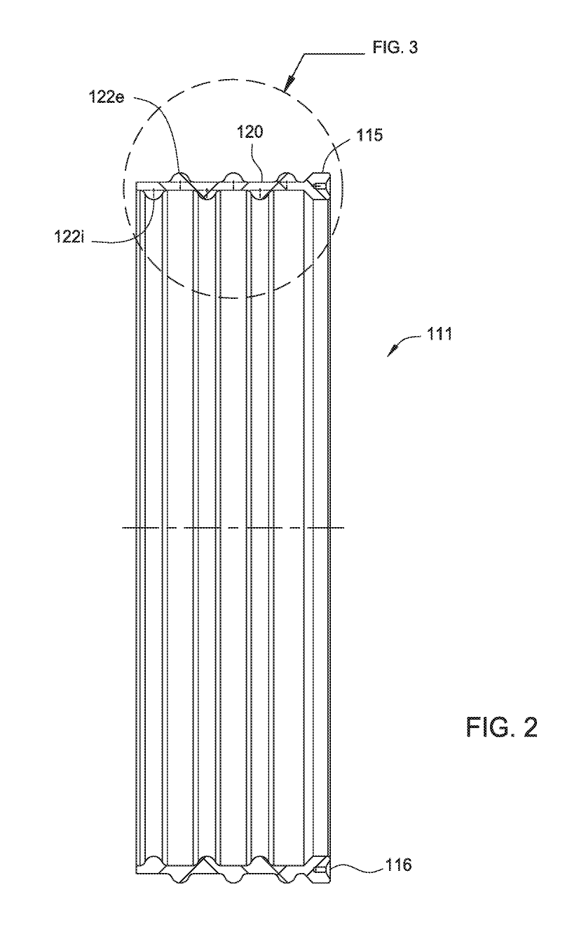

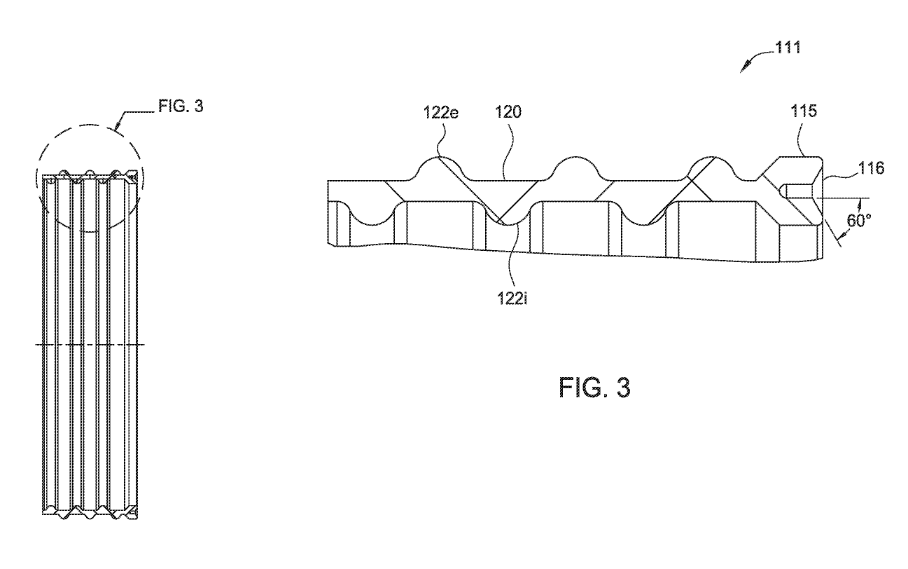

The seal 100 includes two sealing members 111, 112 disposed on opposite sides of a third sealing member 113. An exemplary third sealing member 113 is an o-ring. FIG. 2 is a cross-sectional view of a sealing member 111, 112, and FIG. 3 is an enlarged, partial view of FIG. 2. Each of the opposing sealing members 111, 112 has a tubular shape and includes a y-shaped end 115. The y-shaped end 115 forms a pocket 116 for engaging the third sealing member 113. The third sealing member 113 is disposed between and engaged with the y-shaped ends 115 of the two sealing members 111, 112. The y-shaped ends 115 of the opposing sealing members 111, 112 and the third sealing member 113 are configured to form an interference fit with the downhole tubular.

The opposing sealing members 111, 112 include a cylindrical body 120 and one or more sealing elements 112e, 122i disposed on the interior surface and the exterior surface of the cylindrical body 120. The interior sealing elements 122i extend radially inward from the body 120, and the exterior sealing elements 122e extend radially outward from the body 120. The sealing elements 122e, 122i extend circumferentially around the cylindrical body 120. In one embodiment, the sealing elements 122e, 122i are integral with the body 120, thereby forming a one-piece sealing member. The sealing members 111, 112 may comprise a thermosplatic material. The sealing elements 122e, 122i allow the seal 100 to be self-sealing when a fluid pressure is encountered. Exemplary fluids include liquid, gas, and combinations thereof. As shown, the sealing elements 122e, 122i on the same side of the body 120 are equally spaced along the body 120. However, the sealing elements 122e, 122i may be spaced at any suitable distance from each other. In one embodiment, the interior sealing elements 122i are axially offset from the exterior sealing elements 122e. In this respect, the offsetting sealing elements 122e, 122i may provide flexibility to seal member 111, 112. This embodiment may be referred to herein as a “wave” seal. As shown in FIGS. 1 and 3, the interior sealing elements 122i are alternately spaced with the exterior sealing elements 122e. A pocket 119 is formed by two adjacent interior sealing elements 122i and interior surface of the body 120. The exterior sealing element 122e located on the exterior side of the body 120 opposite the pocket 119 can move toward the pocket 119 in response to a fluid pressure. It may be possible that the exterior sealing element 122e moves sufficiently away from the PBR to lose contact with the PBR. Similarly, outer pockets are formed between two adjacent exterior sealing elements 122e and the exterior surface of the body 120. In another embodiment, the body 120 may be sufficiently rigid to prevent movement of the exterior sealing element 122e toward the pocket, or may allow a small amount of movement but maintaining the sealing element 122e in contact with the PBR. Some flexibility of the body 120 is preferable, especially during insertion of the mandrel 15. In another embodiment, the sealing elements 122i, 122e may bend relative to the body 120 during insertion into the PBR. For example, the exterior sealing elements 122e may bend upward due to frictional contact with the PBR. In another embodiment, the side of the body 120 forming the pocket 119 may be arcuate. For example, the arcuate surface may be recessed and shallower than the sealing element on the opposite side. This example would result in a sealing member 111 having an overall shape with similarities to an “S” shape. It is contemplated that one or more of the interior sealing elements 122i may be axially aligned or partially overlap with a respective exterior sealing element 122e. It is also contemplated that two sealing elements 122e, 122i on one side of the body 120 may be positioned between two sealing elements 122e, 122i on the other side of the body 120. Also, the sealing elements 122e, 122i closest to the y-shaped ends 115 may be either an interior sealing element 122i or an exterior sealing element 122e.

In one embodiment, the sealing element 122e, 122i has an arcuate shape. In one example, the sealing elements 122e, 122i have a semicircle outer shape. The outer shape may have a curved transition with the outer surface of the body 120. The ratio of the height of the sealing elements 122e, 122i extending from the surface of the cylindrical body 120 to the thickness of the cylindrical body 120 may be from 0.3:1 to 1:1.3; preferably from 0.5 to 1. The outer diameter of the outer sealing element 122e is larger than the outer diameter of the cylindrical body 120, while the outer diameter of the inner sealing elements 122i is smaller than the outer diameter of the cylindrical body 120. In one embodiment, the outer diameters of the exterior and interior sealing elements 122e, 122i have sufficient size to form an interference fit with the downhole PBR (or the liner) and the mandrel 15, respectively. Also, the ratio of the width of the sealing elements 122e, 122i to the distance between two adjacent sealing elements 122e, 122i on the same side of the body 120 may be from 0.3:1 to 1:1.3; preferably from 0.5 to 1. When the sealing elements 122e, 122i have a semicircle shape, the width is twice the height of the sealing elements 122e, 122i. Each side of the body 120 may have the same or different number of sealing elements 122e, 122i. In one embodiment, three sealing elements 122e, 122i are positioned on each side of the body 120. However, each side of the body 120 may have one, two, four, five, six, or more sealing elements 122e, 122i. It is also contemplated the opposing sealing members 111, 112 may have different number of sealing elements 122e, 122i.

In operation, the seal 100 is disposed on the exterior of a mandrel 15 and lowered into the wellbore. The seal 100 may be installed by heat shrinking the seal 100 around the mandrel 15. The seal 100 may be made from a thermoplastic material or other suitable material. The mandrel 15 is stabbed into the bore of a tubular such as a PBR 35. The exterior and interior sealing elements 122e, 122i form an interference fit with the PBR 35 and the mandrel 15. When encountering a fluid pressure, the sealing elements 122e, 122i form a tortuous path for the fluid pressure. See FIG. 3A. The fluid pressure acts on the alternating sealing elements 122e, 122i, which causes the seal 100 to form a fluid tight seal between the mandrel 15 and the PBR 35. As shown in FIG. 3A, the fluid pressure initially acts on the distal sealing elements 122ea, 122ia. In this example, the fluid pressure has moved the exterior sealing element 122ea away from the PBR 35 and toward the pocket 119. Also, the fluid pressure has compressed the interior sealing elements 122ia, 122ib toward the mandrel 15. Moving inward, the exterior sealing element 122eb remains in contact with the PBR 35. In this manner, a fluid tight seal is formed to prevent passage of fluids such as liquid and gas through the seal 100.

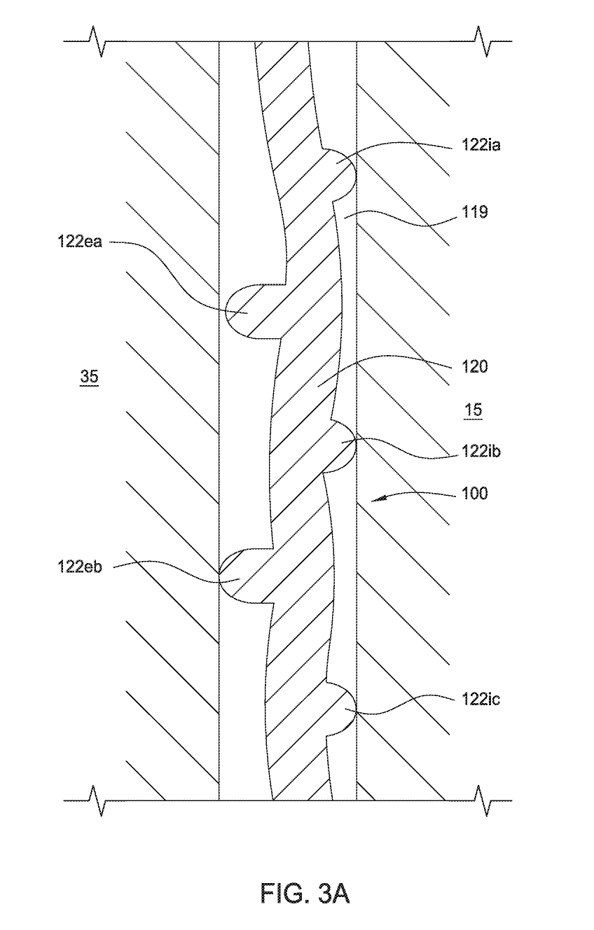

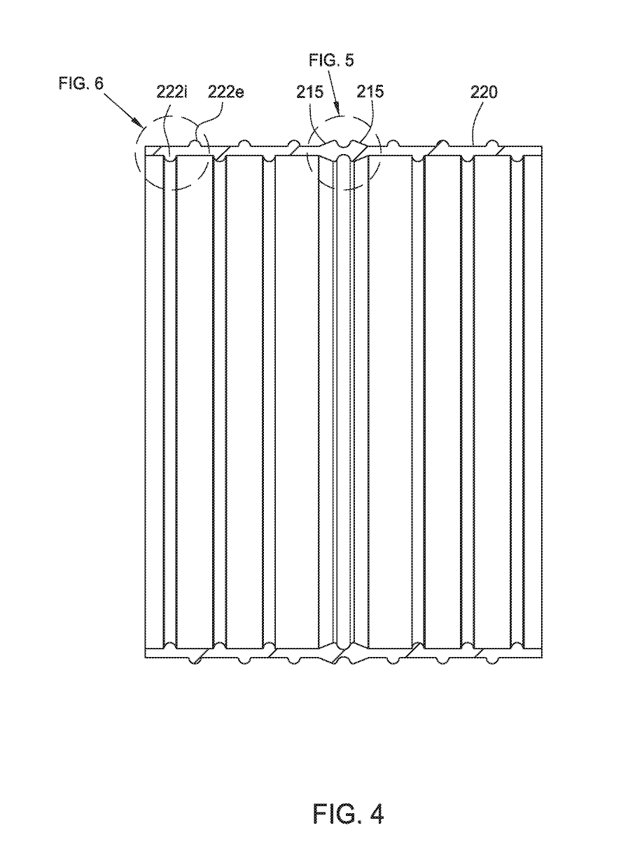

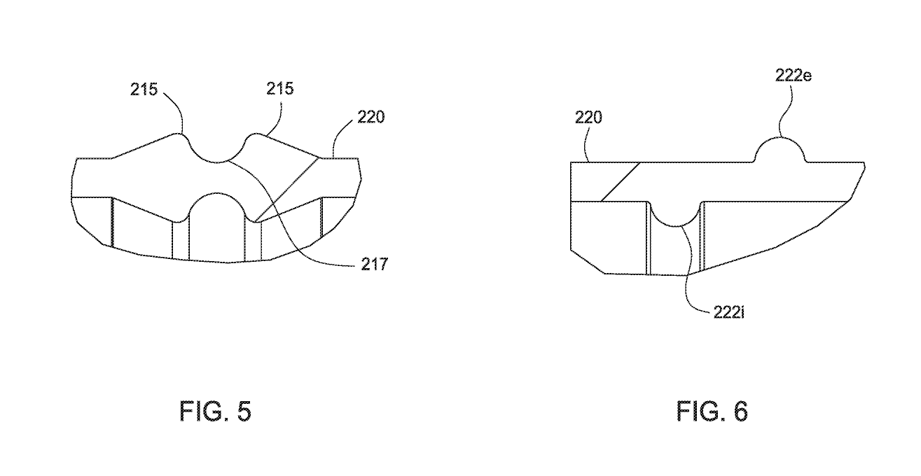

FIG. 4 illustrates another embodiment of a seal 200. FIGS. 5 and 6 are enlarged partial views of the seal 200 of FIG. 4. The seal 200 may be interchanged with the seal 100 on the mandrel 15. In this embodiment, the seal 200 is an integrated seal 200 having sealing elements 222e, 222i on either side of the y-shaped members 215. The y-shaped members 215 are connected and oppose each other in direction. For sake of clarity, the arrangement and size of the interior and exterior sealing elements 222e, 222i may be the same as the sealing elements 122e, 122i described above with respect to FIGS. 1 to 3, and will not be described in detail. It is contemplated that the seal 200 may have the same or different number of sealing elements 222e, 222i on either side of the y-shaped members 215. The portion 217 connecting the y-shaped members 215 may have an outer diameter that is smaller than or same as the outer diameter of the y-shaped members 215.

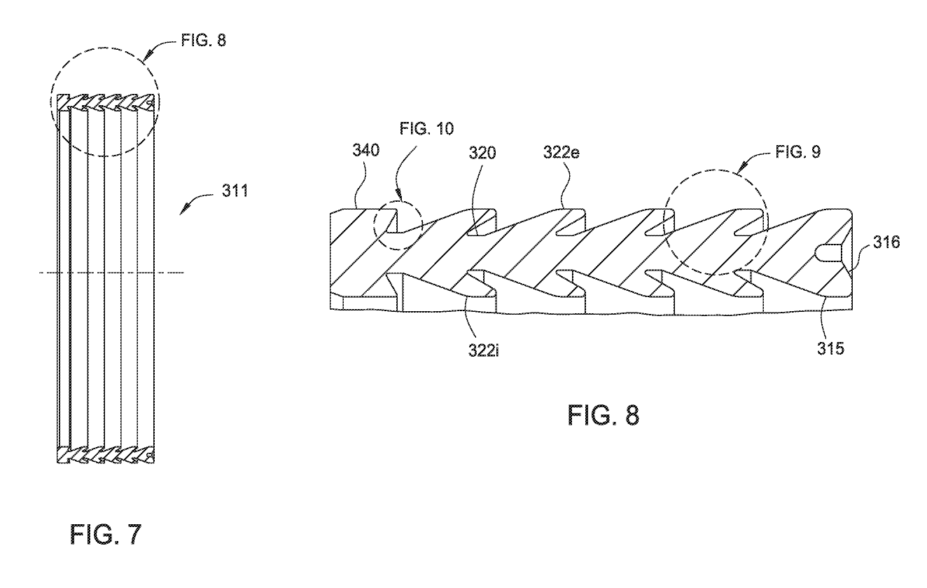

FIG. 7 shows a cross-sectional view of another embodiment of a downhole sealing member 311. The sealing member 311 may be disposed around the mandrel 15 and stabbed into a tubular such as a polished bore receptacle (“PBR”) or a liner instead of sealing member 111 of FIG. 1. In this respect, two sealing members 311 may be disposed on opposites sides of a third sealing member 113. The sealing members 311 may be disposed between two protrusions 20 for axially retaining the sealing members 311 and the third sealing member 113 on the mandrel 15. An exemplary third sealing member 113 is an o-ring.

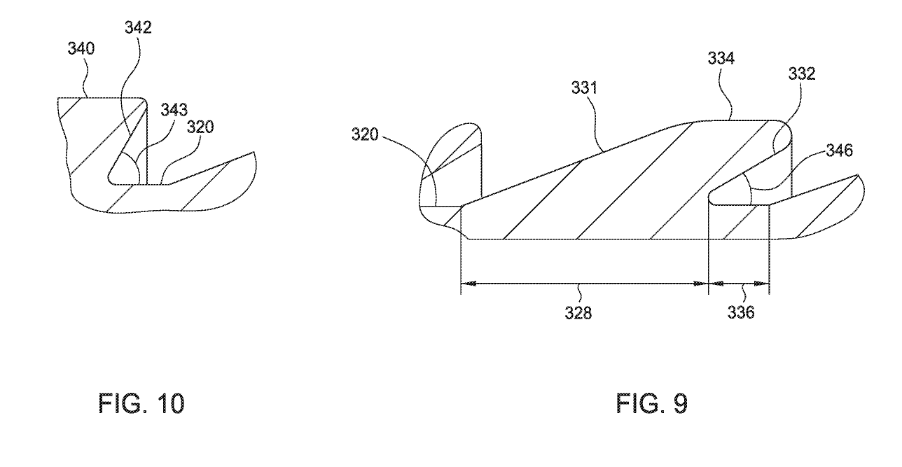

FIG. 8 is an enlarged, partial view of the sealing member 311 of FIG. 7. FIGS. 9 and 10 are enlarged partial views of the sealing member 311 of FIG. 8. Each of the sealing members 311 has a tubular shape and includes a y-shaped end 315. The y-shaped end 315 forms a pocket 316 for engaging the third sealing member 313. The third sealing member 313 is disposed between and engaged with the y-shaped ends 315 of the two sealing members 311. The y-shaped ends 315 of the opposing sealing members 311 and the third sealing member 313 are configured to form an interference fit with the downhole tubular.

The opposing sealing members 311 include a cylindrical body 320 and one or more sealing elements 322e, 322i disposed on the interior surface and the exterior surface of the cylindrical body 320. The interior sealing elements 322i extend radially inward from the body 320, and the exterior sealing elements 322e extend radially outward from the body 320. The sealing elements 322e, 322i extend circumferentially around the cylindrical body 320. As shown, the sealing elements 322e, 322i are angled toward the y-shaped member 315. In one embodiment, the sealing elements 322e, 322i are integral with the body 320, thereby forming a one-piece sealing member 311. The sealing members 311 may comprise a thermosplatic material. Referring to FIG. 9, in one embodiment, the front edge 331 of the sealing element 322e may have a smaller angle relative to the longitudinal axis of the body 320 than the back edge 332 of the sealing element 322e. The distal end of the back edge 332 may angle back toward the base 328 formed between the front edge 331 and the back edge 332 of the sealing elements 333e, 322i. This embodiment may be referred to herein as an “arrow” seal. As shown, a spacer portion 334 connects the distal end of the front edge 331 to the distal end of the back edge 332. It is contemplated that the distal ends may connect directly to each other. The sealing elements 322e, 322i on the same side of the body 320 are equally spaced along the body 320. However, the sealing elements 322e, 322i may be spaced at any suitable distance from each other. In this embodiment, the interior sealing elements 322i are axially aligned with the exterior sealing elements 322e. However, the sealing elements 322e, 322i may be axially offset from each other. It is contemplated that one or more of the interior sealing elements 322i may be axially aligned or partially overlap with a respective exterior sealing element 322e. It is also contemplated that two sealing elements 322e, 322i on one side of the body 320 may be positioned between two sealing elements 322e, 322i on the other side of the body 320.

In one embodiment, the ratio of the radial height of the sealing elements 322e, 322i extending from the surface of the cylindrical body 320 to the thickness of the cylindrical body 320 may be from 0.3:1 to 1:1.3; preferably from 0.5 to 1. The outer diameter of the sealing member 311 should have sufficient size to form an interference fit with the downhole PBR or the liner. Also, the length of the base 328 between the front edge 331 and the back edge 332 of a sealing element 322e, 322i may be from 2.5X to 20X the distance 336 between two adjacent sealing elements 322e, 322i on the same side of the body 320. In one embodiment, the length of the base 328 is from 5X to 10X the distance 336 between two adjacent sealing elements 322e, 322i. In another embodiment, the base 328 is longer than the spacer portion 334. Each side of the body 320 may have the same or different number of sealing elements 322e, 322i. In one embodiment, four sealing elements 322e, 322i are positioned on each side of the body 320. However, each side of the body 320 may have one, two, three, five, six, or more sealing elements 322e, 322i. It is also contemplated the opposing sealing members 311 may have different number of sealing elements 322e, 322i. In one embodiment, the sealing element 311 may have a front portion 340. The back edge 342 of the front portion 340 may have the same or larger angle 343 relative to the longitudinal axis of the body 320 than the angle 346 of the back edge 332 of a sealing element 332e, 322i. For example, the back edge 342 of the front portion 340 may have a 60 degree angle 343, and the back edge 332 of the sealing element 322e may have a 30 degree angle 346. Also, the outer diameter of the front portion 340 may be smaller than the outer diameter of the sealing element 322e.

In operation, two sealing members 311 are used in combination with an o-ring to form a seal between a mandrel 15 and a tubular such as a PBR. The two sealing members 311 are disposed on opposite sides of the o-ring and arranged such that the front end 340 of the sealing members 311 are positioned distally from the o-ring. The mandrel 15 and the sealing members 311, 113 are lowered into the wellbore and stabbed into the bore of a tubular such as a PBR. The exterior and interior sealing elements 322e, 322i form an interference fit with the PBR and the mandrel 15. During insertion, the sealing elements 322e, 322i may bend relative to the body 320 due to frictional contact with the PBR. A fluid pressure from one side of the sealing members 311, 113 may flow past the sealing member 311 on the same side and act on the sealing elements 322e, 322i of the sealing member 311 on the opposite side as well as the o-ring. In this respect, the sealing members 311, 113 cooperate to form a fluid tight seal between the mandrel 15 and the PBR.

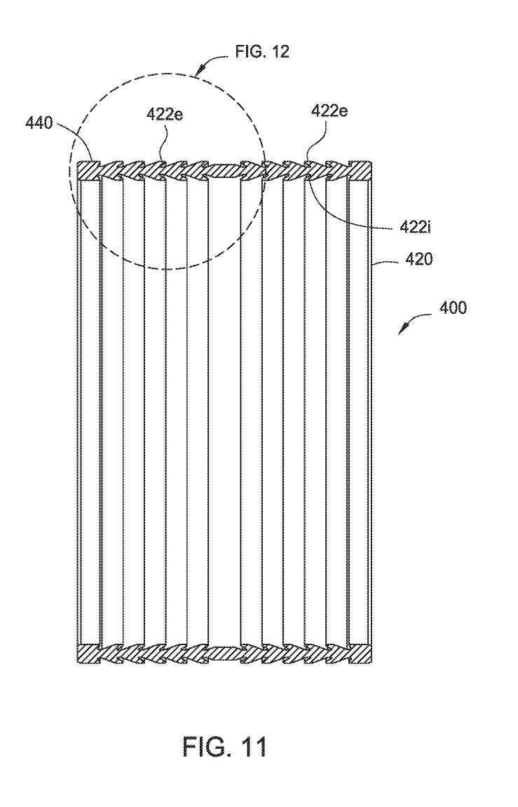

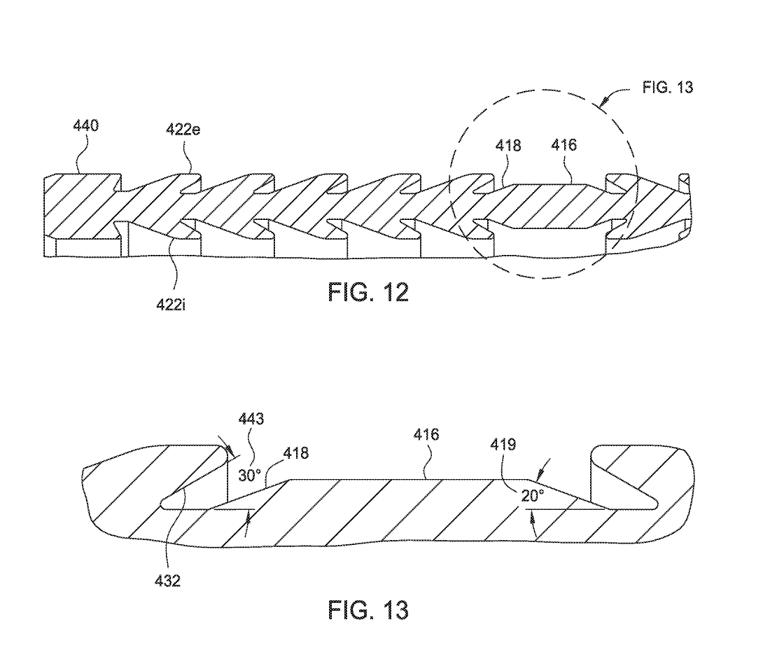

FIGS. 11-13 illustrate another embodiment of a seal 400. FIG. 12 is an enlarged partial view of the seal 400 of FIG. 11, and FIG. 13 is an enlarged partial view of FIG. 12. The seal 400 may be exchanged with the seals 100, 200, 311 on the mandrel 15. In this embodiment, the seal 400 is an integrated seal 400 having one or more pairs of sealing elements 422e, 422i arranged in opposite axial directions of the cylindrical body 420. For sake of clarity, sealing elements 422e, 422i may be substantially the same as the sealing elements 322e, 322i described above with respect to FIGS. 7 to 10, and will not be further described in detail. The opposing pairs of sealing elements are connected via a connecting portion 416. As shown, the seal 400 includes five pairs of sealing elements 422i, 422e on each side of the connecting portion 416. It is contemplated that the seal 400 may have the same or different number of sealing elements 422e, 422i on either side of the connecting portion 416. For example, each side may individually have two, three, four, six, or seven pairs of sealing elements 422e, 422i. The connecting portion 416 may have an outer diameter that is smaller than or same as the outer diameter of the sealing elements 422e, 422i. In this embodiment, the outer diameter of the connecting portion 416 is smaller than the outer diameter of the sealing elements 422e, 422i, but larger than the outer diameter of the body 420. Each side of the connecting portion 416 may include an incline 418 having a smaller angle 419 than the angle 443 of the back edge 432 of the sealing elements 422e. For example, the incline 418 may have a 20 degree angle while the angle 443 of the back edge 432 is 30 degrees. Each side of the seal 400 may include a front portion 440 substantially similar to the front portion 340 of FIG. 8.

In operation, the seal 400 is installed around the mandrel 15. The seal 400 may be heated and disposed around the mandrel 15, where it will shrink fit around the mandrel 15. The mandrel 15 and the seal 400 are lowered into the wellbore and stabbed into the bore of a tubular such as a PBR. The exterior and interior sealing elements 422e, 422i form an interference fit with the PBR and the mandrel 15. A fluid pressure from one side of the seal 400 may flow past the sealing elements on the same side and act on the sealing elements of the seal 400 on the opposite side. In this manner, the seal 400 forms a fluid tight seal between the mandrel 15 and the PBR.

Even though the above disclosure describes apparatus and method for aligning drilling tools, casing tools, and cementing tools with a top drive, the present disclosure encompasses apparatus and method for aligning any suitable tools.

In one embodiment, a downhole seal includes cylindrical body; a plurality of exterior sealing elements disposed on an exterior surface of the body; and a plurality of interior sealing elements disposed on an interior surface of the body, wherein the exterior sealing elements are offset from the interior sealing elements along the body.

In another embodiment, a downhole seal includes a cylindrical body; a plurality of exterior sealing elements disposed at an angle on an exterior surface of the body; and a plurality of interior sealing elements disposed at an angle on an interior surface of the body, wherein the exterior sealing elements are aligned with the interior sealing elements and angled in the same direction.

In one or more of the embodiments described herein, the plurality of exterior sealing elements extends radially from the body.

In one or more of the embodiments described herein, the plurality of exterior sealing elements includes a front edge; and a back edge, wherein the front edge and the back edge are inclined at different angles relative to a longitudinal axis of the body.

In one or more of the embodiments described herein, the seal includes a spacer portion connecting the front edge and the back edge.

In one or more of the embodiments described herein, the seal further comprises oppositely angled sealing members.

In one or more of the embodiments described herein, the seal includes a connecting portion disposed between the oppositely angled sealing members.

In one or more of the embodiments described herein, the seal comprises a thermoplastic material.

In one or more of the embodiments described herein, the plurality of exterior sealing elements comprises an arcuate shape.

In one or more of the embodiments described herein, the seal further comprises a y-shaped end.

In one or more of the embodiments described herein, the seal further comprises opposing y-shaped portions.

In one or more of the embodiments described herein, the seal includes a plurality of exterior and interior sealing elements disposed on either side of the opposing y-shaped portions.

In another embodiment, a downhole seal includes a first sealing member and a second sealing member, wherein each of the first and second sealing members includes a cylindrical body; a plurality of exterior sealing elements disposed on an exterior surface of the body; and a plurality of interior sealing elements disposed on an interior surface of the body, wherein the exterior sealing elements are offset from the interior sealing elements along the body. The seal also includes a third sealing member disposed between the first sealing member and the second sealing member.

In another embodiment, a downhole seal includes a first sealing member; a second sealing member, wherein each of the first and second sealing members includes a cylindrical body; a plurality of exterior sealing elements disposed at an angle on an exterior surface of the body; and a plurality of interior sealing elements disposed at an angle on an interior surface of the body, wherein the exterior sealing elements are aligned with the interior sealing elements and angled in the same direction; and a third sealing member disposed between the first sealing member and the second sealing member, wherein the respective sealing elements of the first sealing member and the second sealing member are angled in opposite directions.

In one or more of the embodiments described herein, each of the first and second sealing members include a y-shaped end, and the y-shaped ends face each other.

In one or more of the embodiments described herein, the y-shaped ends contact the third sealing member.

In one or more of the embodiments described herein, the third sealing member comprises an elastomer.

In one or more of the embodiments described herein, the second sealing member comprises a thermoplastic material.

In one or more of the embodiments described herein, the third sealing member comprises an o-ring.

While the foregoing is directed to embodiments of the present disclosure, other and further embodiments of the disclosure may be devised without departing from the basic scope thereof, and the scope of the invention is determined by the claims that follow.

1. A downhole seal, comprising:
a cylindrical body;
a plurality of exterior sealing elements disposed on an exterior surface of the body; and
a plurality of interior sealing elements disposed on an interior surface of the body, wherein the exterior sealing elements are offset from the interior sealing elements along the body.

2. The seal of claim 1, wherein the plurality of exterior sealing elements extends radially from the body.

3. The seal of claim 1, wherein the plurality of exterior sealing elements comprises an arcuate shape.

4. The seal of claim 1, wherein the seal further comprises a y-shaped end.

5. The seal of claim 1, wherein the seal further comprises opposing y-shaped portions.

6. The seal of claim 5, further comprising a plurality of exterior and interior sealing elements disposed on either side of the opposing y-shaped portions.

7. The seal of claim 1, wherein the seal comprises a thermoplastic material.

8. The seal of claim 1, wherein the body is flexible.

9. The seal of claim 1, wherein a pocket is formed between two adjacent interior sealing elements.

10. The seal of claim 9, wherein the seal is a one-piece seal.

11. A downhole seal, comprising:
a first sealing member;
a second sealing member, wherein each of the first and second sealing members include:
a cylindrical body;
a plurality of exterior sealing elements disposed on an exterior surface of the body; and
a plurality of interior sealing elements disposed on an interior surface of the body, wherein the exterior sealing elements are offset from the interior sealing elements along the body; and
a third sealing member disposed between the first sealing member and the second sealing member.

12. The seal of claim 11, wherein each of the first and second sealing members include a y-shaped end, and the y-shaped ends face each other.

13. The seal of claim 12, wherein the y-shaped ends contact the third sealing member.

14. The seal of claim 11, wherein a pocket is formed between two adjacent interior sealing elements.

15. A downhole seal, comprising:
a cylindrical body;
a plurality of exterior sealing elements disposed at an angle on an exterior surface of the body; and
a plurality of interior sealing elements disposed at an angle on an interior surface of the body, wherein the exterior sealing elements are aligned with the interior sealing elements and angled in the same direction.

16. The seal of claim 15, wherein the plurality of exterior sealing elements extends radially from the body.

17. The seal of claim 15, wherein the plurality of exterior sealing elements include:
a front edge; and
a back edge, wherein the front edge and the back edge are inclined at different angles relative to a longitudinal axis of the body.

18. The seal of claim 17, further comprising a spacer portion connecting the front edge and the back edge.

19. The seal of claim 15, wherein the seal further comprises oppositely angled sealing members.

20. The seal of claim 19, further comprising a connecting portion disposed between the oppositely angled sealing members.
